(19) United States
(12) Patent Application Publication
(10) Pub. No.: US 2025/0127213 A1
(43) Pub. Date: Apr. 24, 2025

(54) MOUTHPIECE STRUCTURE AND AEROSOL GENERATION DEVICE

(71) Applicant: Shenzhen Verdewell Technology Limited, Shenzhen (CN)

(72) Inventors: Yingxin YANG, Shenzhen (CN); Guoliang OU, Shenzhen (CN); Jianguang ZHOU, Shenzhen (CN); An WANG, Shenzhen (CN)

(21) Appl. No.: 18/918,785

(22) Filed: Oct. 17, 2024

(30) Foreign Application Priority Data
Oct. 19, 2023 (CN) 202322820786.9

(51) Int. Cl. A24F 7/02; A24F 40/485; F16B 7/04

(52) U.S. Cl. CPC A24F 7/02; A24F 40/485; F16B 7/0413

(57) ABSTRACT

A mouthpiece structure includes: a mouthpiece body having an outer cylinder and an inner cylinder extending from a top end of the outer cylinder into an inner cavity of the outer cylinder; and a connector arranged in the inner cavity of the outer cylinder, the connector and the inner cylinder being arranged in an axial direction of the outer cylinder, the connector being sleeved outside a vent tube. The inner cylinder has an air guide hole and a plug hole that are in communication with each other, the plug hole being plug-fitted with a top end of the vent tube. The air guide hole docks with a top end of the vent tube to guide an airflow out of the vent tube. The connector is configured to snap with the vent tube. The connector is snapped with the outer cylinder.

### CROSS-REFERENCE TO PRIOR APPLICATION

Priority is claimed to Chinese Patent Application No. 202322820786.9, filed on Oct. 19, 2023, the entire disclosure of which is hereby incorporated by reference herein.

### FIELD

This application relates to the technical field of aerosol generation, and more specifically, to a mouthpiece structure and an aerosol generation device.

### BACKGROUND

An aerosol generation device is configured to heat and atomize an atomizable liquid substrate, to generate an inhalable aerosol. The aerosol generation device generally includes a mouthpiece structure, an atomization structure, and a power supply structure. The power supply structure is configured to supply power to the atomization structure. The atomization structure is configured to heat and atomize a liquid substrate after powered on to form an aerosol. The mouthpiece structure is connected to the atomization structure and is configured to guide an airflow carrying the aerosol out.

The atomization structure is generally in communication with the mouthpiece structure through a vent tube. To improve the reliability of connection between the vent tube and the mouthpiece structure, the mouthpiece structure and the vent tube are generally connected by snapping. The mouthpiece structure is further formed with an air guide hole and a plug hole that are in communication with each other. The plug hole is used to be plug-fitted with the top end of the vent tube. The air guide hole is used to dock with the top end of the vent tube to guide an airflow out of the vent tube. A step is formed at a junction between the air guide hole and the plug hole. Due to the arrangement of the step structure and the snap structure, the mouthpiece structure is difficult to demold during molding.

### SUMMARY

In an embodiment, the present invention provides a mouthpiece structure, comprising: a mouthpiece body comprising an outer cylinder and an inner cylinder extending from a top end of the outer cylinder into an inner cavity of the outer cylinder; and a connector arranged in the inner cavity of the outer cylinder, the connector and the inner cylinder being arranged in an axial direction of the outer cylinder, the connector being sleeved outside a vent tube, wherein the inner cylinder comprises an air guide hole and a plug hole that are in communication with each other, the plug hole being plug-fitted with a top end of the vent tube, wherein the air guide hole is configured to dock with a top end of the vent tube to guide an airflow out of the vent tube, wherein the connector is configured to snap with the vent tube, and wherein the connector is snapped with the outer cylinder.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic three-dimensional structural diagram of an aerosol generation device according to an embodiment of this application;

FIG. 2 is a schematic longitudinal cross-sectional view of the aerosol generation device in FIG. 1 along a first cross section;

FIG. 3 is a schematic longitudinal cross-sectional view of the aerosol generation device in FIG. 1 along a second cross section, where the second cross section is a cross section through an elastic arm;

FIG. 4 is a schematic enlarged view of part A in FIG. 2;

FIG. 5 is a schematic structural diagram of a mouthpiece body in an aerosol generation device according to an embodiment of this application;

FIG. 6 is a schematic structural diagram of a connector in an aerosol generation device according to an embodiment of this application; and

FIG. 7 is a schematic structural diagram of a vent tube in an aerosol generation device according to an embodiment of this application.

### DETAILED DESCRIPTION

In an embodiment, the present invention provides a mouthpiece structure and an aerosol generation device, to resolve a technical problem in the related art that the mouthpiece structure is difficult to demold during molding due to the arrangement of the step structure and the snap structure.

To achieve the foregoing objective, this application adopts the following technical solutions: A mouthpiece structure is provided. The mouthpiece structure includes a mouthpiece body and a connector. the mouthpiece body includes an outer cylinder and an inner cylinder extending from the top end of the outer cylinder into the inner cavity of the outer cylinder; the connector is arranged in the inner cavity of the outer cylinder, and the connector and the inner cylinder are arranged in the axial direction of the outer cylinder; the connector is sleeved outside a vent tube, the inner cylinder is formed with an air guide hole and a plug hole that are in communication with each other, the plug hole is used to be plug-fitted with the top end of the vent tube, and the air guide hole is used to dock with the top end of the vent tube to guide an airflow out of the vent tube; and the connector is used to snap with the vent tube, and the connector is snapped with the outer cylinder.

In a possible design, the inner wall of the outer cylinder is formed with a first clamping block, the outer wall of the connector is formed with a second clamping block, and the first clamping block is, when driven by an external force, snapped into one side of the second clamping block away from the inner cylinder from one side of the second clamping block towards the inner cylinder and locked.

In a possible design, the connector is formed with an opening at the position corresponding to the second clamping block, the opening runs axially through one end of the connector away from the inner cylinder, and the opening runs radially through the side wall of the connector.

In a possible design, the connector is formed with a window, the inner wall of the window is extended with an elastic arm, the elastic arm is used to elastically abut against the outer wall of the vent tube, and the elastic arm is further used to elastically snap with a convex ring on the outer wall of the vent tube.

In a possible design, the inner diameter of the air guide hole gradually increases from the plug hole to the direction away from the plug hole, the minimum inner diameter of the air guide hole is less than the inner diameter of the plug hole, and the minimum inner diameter of the air guide hole is less than the inner diameter of the vent tube.

Beneficial effects of the mouthpiece structure provided in this application are as follows: According to the mouthpiece structure provided in the embodiments of this application, the mouthpiece structure is divided into two structural parts: a mouthpiece body and a connector. An inner cylinder of the mouthpiece body is formed with an air guide hole and a plug hole. The plug hole is used to be plug-fitted with the top end of a vent tube. The air guide hole is used to dock with the top end of the vent tube to guide an airflow out of the vent tube, and the mouthpiece body is connected the vent tube through the connector. In other words, the step structure and the snap structure of the mouthpiece structure are respectively formed on the mouthpiece body and the connector. In this way, the structures of the mouthpiece body and the connector are simplified, which facilitates the demolding of the mouthpiece body and the connector, so that both the mouthpiece body and the connector can be molded by using a mold.

According to another aspect, this application further provides an aerosol generation device, including a vent tube, a main housing, and the foregoing mouthpiece structure. the main housing is sleeved outside the vent tube, the mouthpiece structure is connected to the top end of the main housing, and the mouthpiece structure is sleeved on the top end of the vent tube.

In a possible design, the aerosol generation device further provides a sealing member. the sealing member abuts between the outer wall of the vent tube and the inner wall of the main housing, and the sealing member axially abuts between the outer cylinder and the main housing.

In a possible design, the sealing member is sleeved between the vent tube and the main housing, the inner wall of the sealing member abuts against the outer wall of the vent tube, the outer wall of the sealing member abuts against the inner wall of the main housing, the outer wall of the sealing member is extended with an abutting ring, and the abutting ring axially abuts between the outer cylinder and the main housing.

In a possible design, one side of the sealing member towards a connector is formed with an accommodation groove, one end of the connector away from the inner cylinder is plugged into the accommodation groove, and the inner wall and the outer wall of the connector respectively abut against the opposing inner walls of the accommodation groove.

In a possible design, the top end of the vent tube includes a sealing section and a snapping section, where the sealing section hermetically abuts against the sealing member, and the snapping section is convexly provided with a convex ring for snapping with the connector; and the outer diameter of the sealing section is greater than the outer diameter of the snapping section.

Beneficial effects of the aerosol generation device provided in this application are as follows: According to the aerosol generation device provided in the embodiments of this application, the foregoing design of the mouthpiece structure simplifies a processing process of the mouthpiece structure, thereby reducing processing costs of the aerosol generation device.

Reference numerals in the accompanying drawings are as follows.
100. Mouthpiece structure; 110. Mouthpiece body; 111. Inner cylinder; 112. Outer cylinder; 113. Air guide hole; 114. Plug hole; 115. First clamping block; 1151. First abutting surface; 1152. First guiding surface; 120. Connector; 121. Second clamping block; 1211. Second abutting surface; 1212. Second guiding surface; 1213. Limiting surface; 122. Opening; 123. Window; 124. Elastic arm; 200. Atomization structure; 210. Vent tube; 211. Sealing section; 212. Snapping section; 213. Convex ring; 220. Main housing; 230. Atomization core; 240. Liquid storage cavity; 300. Sealing member; 310. First sealing ring; 320. Connecting ring; 330. Second sealing ring; 340. Abutting ring; 350. First convex rib; 360. Second convex rib; 370. Accommodation groove.

To make the technical problem to be resolved by this application, technical solutions, and beneficial effects more comprehensible, the following further describes this application in detail with reference to the accompanying drawings and embodiments. It should be understood that the specific embodiments described herein are only used for explaining this application, and are not used for limiting this application.

It should be noted that, when an element is referred to as “being fixed to” or “being arranged on” another element, the element may be directly on the another element, or indirectly on the another element. When an element is referred to be “connected to” another element, the element may be directly connected to the another element, or indirectly connected to the another element.

It should be understood that, orientations or position relationships indicated by terms such as “length”, “width”, “above”, “below”, “front”, “back”, “left”, “right”, “vertical”, “horizontal”, “top”, “bottom”, “inner”, “outer” are based on orientations or position relationship shown in the accompanying drawings, and are merely used for describing this application and simplifying the description, rather than indicating or implying that the device or element needs to have a particular orientation or be constructed and operated in a particular orientation. Therefore, such terms should not be construed as a limitation on this application.

In addition, the terms “first” and “second” are used for descriptive purposes only and are not to be construed as indicating or implying relative importance or implicitly indicating the number of technical features indicated. Therefore, a feature limited by “first” or “second” may explicitly or implicitly include one or more of the features. In the description of this application, “a plurality of” means two or more, unless otherwise definitely and specifically limited.

As described in the BACKGROUND, an atomization structure is generally in communication with a mouthpiece structure through a vent tube. To improve the reliability of connection between the vent tube and the mouthpiece structure, the mouthpiece structure and the vent tube are generally connected by snapping. The mouthpiece structure is further formed with an air guide hole and a plug hole that are in communication with each other. The plug hole is used to be plug-fitted with the top end of the vent tube. The air guide hole is used to dock with the top end of the vent tube to guide an airflow out of the vent tube. A step is formed at a junction between the air guide hole and the plug hole. Due to the arrangement of the step structure and the snap structure, the mouthpiece structure is difficult to demold during molding.

To resolve the foregoing problem, the researchers of this application have come up with an idea, which is specifically to divide the mouthpiece structure into two structural parts, and form the foregoing step structure and snap structure respectively on the two structural parts, thereby resolving the difficulty of demolding the mouthpiece structure.

The original idea of the researchers is to fix the two structural parts together by gluing. However, the connection manner by glue bonding has the following disadvantages: 1. Poor connection reliability. It is susceptible to environmental factors such as temperature and humidity, resulting in loosening and dropping out. 2. Glue affects inhalation. Although a small amount of glue is used, it still smells and contains chemicals, which easily affects inhalation taste. 3. Poor process reliability, and poor consistency of glue bonding in production.

To resolve the foregoing problems, the researchers of this application finally develop a mouthpiece structure after brainstorming, to further resolve the technical problems of poor connection reliability, affected inhalation taste, and poor process reliability caused by the use of glue to bond two structural parts of the mouthpiece structure while resolving the difficulty of demolding the mouthpiece structure.

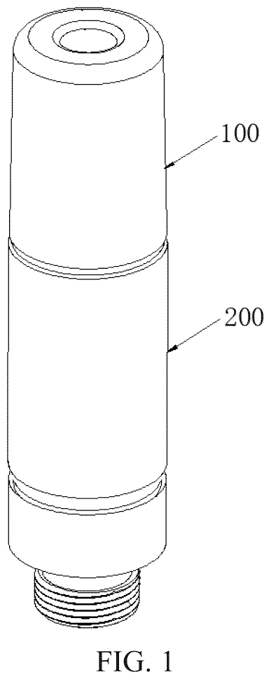

Referring to FIG. 1 to FIG. 3, this application provides an aerosol generation device, including a mouthpiece structure 100, an atomization structure 200, and a power supply structure. The power supply structure is configured to supply power to the atomization structure 200. The atomization structure 200 is configured to accommodate a liquid substrate and heat and atomize the liquid substrate after powered on to form an aerosol. The mouthpiece structure 100 is connected to the atomization structure 200 and is configured to guide an airflow carrying the aerosol out.

In an embodiment, the power supply structure includes a battery, an airflow sensor, and a control circuit. The battery is configured to supply power to each atomization structure 200, the airflow sensor is configured to sense an airflow change, and the control circuit is configured to control the atomization structure 200 to generate heat. The airflow sensor is in communication with an airflow channel of the entire aerosol generation device. The airflow channel runs through the power supply structure, the atomization structure 200, and the mouthpiece structure 100. When a user inhales a mouthpiece body 110, an airflow flows in the airflow channel. The airflow sensor senses the airflow change and feeds back to the control circuit. The control circuit controls the atomization structure 200 to heat the liquid substrate to generate an aerosol. The aerosol is carried by the airflow in the airflow channel and is guided out through the mouthpiece structure 100 for the user to inhale.

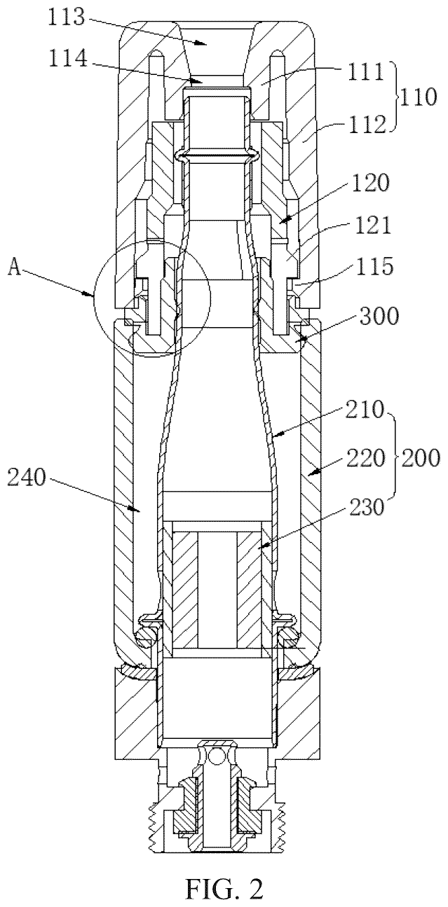

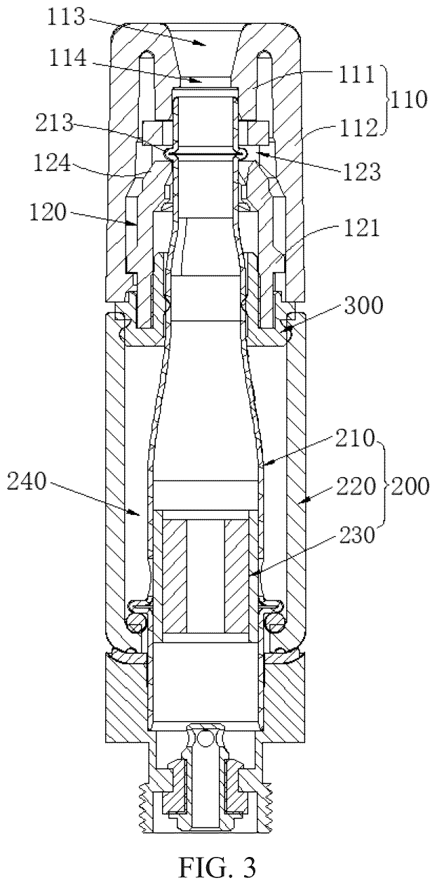

In an embodiment, referring to FIG. 2 and FIG. 3, the atomization structure 200 includes a vent tube 210, and the vent tube 210 is in communication with the mouthpiece structure 100 to deliver the airflow carrying the aerosol to the mouthpiece structure 100.

In an embodiment, referring to FIG. 2 to FIG. 4, the mouthpiece structure 100 includes a mouthpiece body 110 and a connector 120. The mouthpiece body 110 includes an outer cylinder 112 and an inner cylinder 111 extending from the top end of the outer cylinder 112 into the inner cavity of the outer cylinder 112. The connector 120 is arranged in the inner cavity of the outer cylinder 112, and the connector 120 and the inner cylinder 111 are arranged in the axial direction of the outer cylinder 112. The connector 120 is sleeved outside the vent tube 210, and the inner cylinder 111 is formed with an air guide hole 113 and a plug hole 114 that are in communication with each other. The plug hole 114 is used to be plug-fitted with the top end of the vent tube 210, and the air guide hole 113 is used to dock with the top end of the vent tube 210 to guide an airflow out of the vent tube 210. The connector 120 is used to snap with the vent tube 210, and the connector 120 is snapped with the outer cylinder 112.

It should be noted that, during use of the aerosol generation device, the mouthpiece structure 100 is located at the top end of the entire aerosol generation device, and an end of the vent tube 210 used to connect to the mouthpiece body 110 is also located at the top end of the entire vent tube 210. Therefore, for case of description, in this application, an end that faces upward in a use state of each structural part of the aerosol generation device is referred to as the top end, and an end that faces downward is referred to as a bottom end.

According to the mouthpiece structure 100 provided in the embodiments of this application, the mouthpiece structure 100 is divided into two structural parts: the mouthpiece body 110 and the connector 120. The inner cylinder 111 of the mouthpiece body 110 is formed with the air guide hole 113 and the plug hole 114. The plug hole 114 is used to be plug-fitted with the top end of the vent tube 210. The air guide hole 113 is used to dock with the top end of the vent tube 210 to guide the airflow out of the vent tube 210, and the mouthpiece body 110 is connected to the vent tube 210 through the connector 120. In other words, the step structure and the snap structure of the mouthpiece structure 100 are respectively formed on the mouthpiece body 110 and the connector 120. In this way, the structures of the mouthpiece body 110 and the connector 120 are simplified, which facilitates the demolding of the mouthpiece body 110 and the connector 120, so that both the mouthpiece body 110 and the connector 120 can be molded by using a mold.

In addition, the connector 120 of the mouthpiece structure 100 is snapped with the mouthpiece body 110. The snapping is insusceptible to environment factors such as temperature and humidity, and improves the reliability of connection between the connector 120 and the mouthpiece body 110. In addition, the snapping can ensure the consistency in production through the structural design. Finally, a snapping structure introduces no odor, and does not affect the inhalation taste.

In addition, in this application, both the air guide hole 113 and the plug hole 114 are formed in the inner cylinder 111 of the mouthpiece body 110, so that the top end of the mouthpiece structure 100 has a complete and aesthetic appearance.

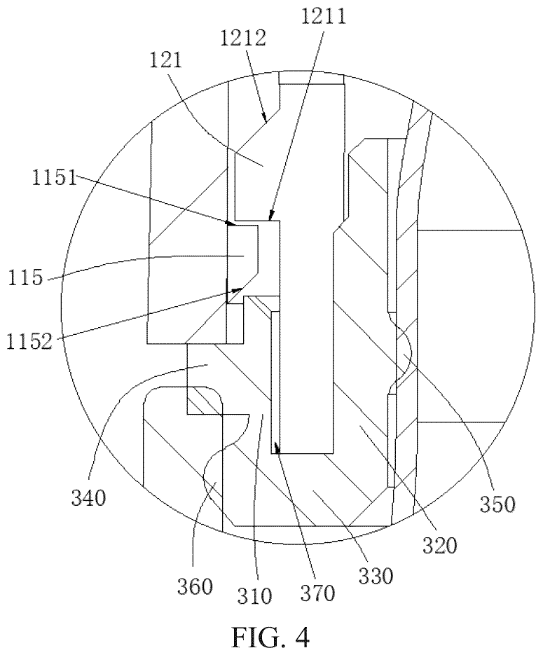

In an embodiment, referring to FIG. 4 to FIG. 6, the inner wall of the outer cylinder 112 is formed with a first clamping block 115, and the outer wall of the connector 120 is formed with a second clamping block 121. The first clamping block 115 can be, driven by an external force, snapped into one side of the second clamping block 121 away from the inner cylinder 111 from one side of the second clamping block 121 towards the inner cylinder 111 and locked.

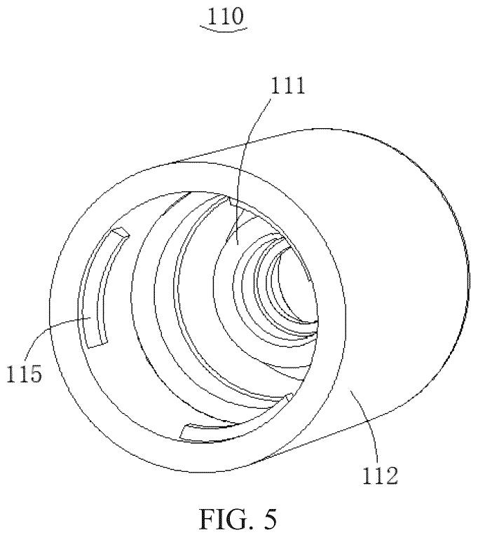

Specifically, the first clamping block 115 and the second clamping block 121 are bumps respectively convexly provided on the outer cylinder 112 and the connector 120. Therefore, both the first clamping block 115 and the second clamping block 121 have an appropriate elastic force. During assembly, the mouthpiece body 110 is slidably sleeved outside the connector 120 in the axial direction of the mouthpiece body 110. During relative sliding of the mouthpiece body 110 and the connector 120, under the clastic forces of the first clamping block 115 and the second clamping block 121, the first clamping block 115 is snapped into one side of the second clamping block 121 away from the inner cylinder 111 from one side of the second clamping block 121 towards the inner cylinder 111 and locked. Alternatively, it may also be described as that the second clamping block 121 is snapped into one side of the first clamping block 115 towards the inner cylinder 111 from one side of the first clamping block 115 away from the inner cylinder 111 and locked. In an embodiment, referring to FIG. 5, a plurality of first clamping blocks 115 are formed on the inner wall of the outer cylinder 112. The first clamping blocks 115 are spaced apart in sequence in the circumferential direction of the outer cylinder 112. The first clamping blocks 115 are respectively snapped with corresponding second clamping blocks 121 on the outer wall of the connector 120, thereby improving the reliability and uniformity of the snapping between the outer cylinder 112 and the connector 120 in the circumferential direction of the outer cylinder 112.

In an embodiment, referring to FIG. 2, the first clamping block 115 is formed at the position near a bottom end of the outer cylinder 112. In this way, the elasticity of the outer cylinder 112 corresponding to the position of the first clamping block 115 and the snapping elasticity of the first clamping block 115 can be improved, which facilitates the snapping between the first clamping block 115 and the second clamping block 121.

In an embodiment, referring to FIG. 5, the second clamping block 121 extends in the circumferential direction of the connector 120 and forms a ring shape, and the first clamping blocks 115 are respectively snapped with the second clamping blocks 121 at different positions in the circumferential direction. In this embodiment, by designing the second clamping block 121 into a ring shape, the difficulty of molding the connector 120 can be reduced. It may be understood that, in other embodiments of this application, a plurality of second clamping blocks 121 may also be formed on the outer wall of the connector 120. The second clamping blocks 121 are equally spaced apart in the circumferential direction of the connector 120. The second clamping blocks 121 are snapped with the first clamping blocks 115 in a one-to-one correspondence.

In an embodiment, referring to FIG. 4, the first clamping block 115 includes a first abutting surface 1151 towards the inner cylinder 111 and a first guiding surface 1152 away from the inner cylinder 111. The second clamping block 121 includes a second guiding surface 1212 towards the inner cylinder 111 and a second abutting surface 1211 away from the inner cylinder 111. The first abutting surface 1151 and the second abutting surface 1211 are both straight surfaces parallel to a radial surface of the outer cylinder 112. The first abutting surface 1151 and the second abutting surface 1211 abut against each other to form an axial limit between the connector 120 and the outer cylinder 112. Both the first guiding surface 1152 and the second guiding surface 1212 are inclined surfaces. The first guiding surface 1152 and the second guiding surface 1212 are used to cooperate with each other to guide the first clamping block 115 and the second clamping block 121 to snap with each other.

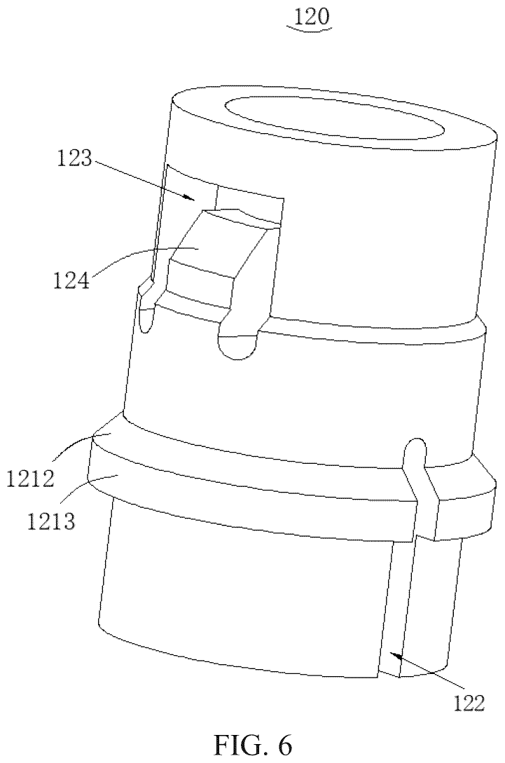

In an embodiment, referring to FIG. 6, the second clamping block 121 further includes a limiting surface 1213. The limiting surface 1213 is used to abut against the inner wall of the outer cylinder 112 to form a radial limit of the connector 120.

In an embodiment, referring to FIG. 6, the connector 120 is formed with an opening 122 at the position corresponding to the second clamping block 121. The opening 122 runs axially through one end of the connector 120 away from the inner cylinder 111, and the opening 122 runs radially through the side wall of the connector 120. By providing the opening 122, the position on the connector 120 corresponding to the second clamping block 121 is disconnected in the circumferential direction, thereby increasing the elasticity of the position on the connector 120 corresponding to the second clamping block 121, and further improving the structural elasticity of the second clamping block 121.

In an embodiment, two openings 122 are provided, and the two openings 122 are spaced apart in the circumferential direction of the connector 120. It may be understood that, in the embodiments of this application, one, three, four, or more than openings 122 may alternatively be provided. This is not uniquely limited herein.

In an embodiment, referring to FIG. 6, the second clamping block 121 extends in the circumferential direction of the connector 120 and forms a ring shape. The connector 120 is formed with an opening 122 at the position corresponding to the second clamping block 121. The opening 122 runs axially through one end of the connector 120 away from the inner cylinder 111, and the opening 122 runs radially through the side wall of the connector 120.

In an embodiment, referring to FIG. 3 and FIG. 5, the connector 120 is formed with a window 123, and the inner wall of the window 123 is extended with an clastic arm 124. Correspondingly, the outer wall of the vent tube 210 is formed with a convex ring 213. The elastic arm 124 is elastically abuts against the outer wall of the vent tube 210, and the clastic arm 124 is further used to elastically snap with the convex ring 213. The formation of the window 123 reduces a circumferential connection area of the clastic arm 124 and improves the elasticity of the elastic arm 124, thereby facilitating the snapping between the connector 120 and the vent tube 210.

During assembly, the mouthpiece body 110 and the connector 120 as a whole are axially sleeved on the top end of the vent tube 210. A suspension end of the elastic arm 124 is snapped into one side of the convex ring 213 away from the inner cylinder 111 from one side of the convex ring 213 towards the inner cylinder 111. The elastic arm 124 abuts against the outer wall of the vent tube 210, and the clastic arm 124 abuts against the convex ring 213. The elastic arm 124 abuts against the outer wall of the vent tube 210 to achieve a radial limit of the vent tube 210, and the clastic arm 124 abuts against the convex ring 213 to achieve an axial limit of the vent tube 210.

It may be understood that, in other embodiments of this application, the inner wall of the connector 120 may also be formed with a third clamping block, and is snapped with the convex ring 213 of the vent tube 210 through the third clamping block.

In an embodiment, referring to FIG. 5, two windows 123 and two clastic arms 124 are provided. In other embodiments of this application, one, three, or more windows 123 and elastic arms 124 may alternatively be provided. This is not uniquely limited herein.

In an embodiment, referring to FIG. 2 and FIG. 3, the inner diameter of the air guide hole 113 gradually increases from the plug hole 114 to the direction away from the plug hole 114. The minimum inner diameter of the air guide hole 113 is less than the inner diameter of the plug hole 114, and the minimum inner diameter of the air guide hole 113 is less than the inner diameter of the vent tube 210.

The minimum inner diameter of the air guide hole 113 is less than the inner diameter of the vent tube 210, so that the airflow guided out of the vent tube 210 can be gathered and converged through the air guide hole 113 for acceleration. However, the inner diameter of the air guide hole 113 gradually increases from the plug hole 114 to the direction away from the plug hole 114. In other words, the air guide hole 113 is substantially cone-shaped, so that the airflow can be guided out through the air guide hole 113.

In an embodiment, referring to FIG. 2 and FIG. 3, the atomization structure 200 further includes a main housing 220 and an atomization core 230. The main housing 220 is sleeved outside the vent tube 210, the mouthpiece structure 100 is connected to the top end of the main housing 220, and the main housing 220 and the vent tube 210 are enclosed to form a liquid storage cavity 240. The atomization core 230 is arranged in the vent tube 210, the side wall of the vent tube 210 is formed with a connecting hole, and a liquid substrate in the liquid storage cavity 240 is provided to the atomization core 230 through the connecting hole. The atomization core 230 heats and atomizes the liquid substrate after powered on, to form an aerosol. An external airflow flows into the vent tube 210 from a bottom of the vent tube 210, and carries away the aerosol generated at the atomization core 230 when passing through the atomization core 230. The airflow carrying the aerosol is delivered to the air guide hole 113 of the inner cylinder 111 through a top of the vent tube 210, and is guided out through the air guide hole 113.

In an embodiment, referring to FIG. 2 to FIG. 4, the aerosol generation device further includes a scaling member 300. The sealing member 300 abuts against the outer wall of the vent tube 210 and the inner wall of the main housing 220. The sealing member 300 axially hermetically abuts between the outer cylinder 112 and the main housing 220. In this embodiment, through one sealing member 300, the main housing 220 may be hermetically connected to the vent tube 210, and the main housing 220 may be hermetically connected to the outer cylinder 112, thereby reducing the risk of the liquid substrate in the liquid storage cavity 240 leaking through gaps between the outer cylinder 112, the connector 120, the vent tube 210, and the main housing 220. In addition, the number of sealing members 300 is reduced, and an assembly process of the scaling member 300 is reduced. In addition, since the sealing member 300 axially abuts between the outer cylinder 112 and the main housing 220, the sealing member 300 may be axially positioned, and there is no need to form a limiting structure on the outer wall of the vent tube 210 to mount the sealing member 300. The structure of the vent tube 210 is simplified, so that the vent tube 210 may be directly formed through a stretching process, thereby reducing a production cost of the vent tube 210.

Generally, in this embodiment, the sealing member 300 abuts between the main housing 220 and the vent tube 210, to form a seal on the top end of the liquid storage cavity 240. It may be understood that, in other embodiments of this application, a seal may also be formed between the connector 120 and the vent tube 210, and then a seal may be formed between the connector 120 and the main housing 220, to form a seal on the top end of the liquid storage cavity 240. This is not uniquely limited herein.

In an embodiment, referring to FIG. 4, the sealing member 300 is sleeved between the vent tube 210 and the main housing 220. The inner wall of the sealing member 300 abuts against the outer wall of the vent tube 210. The outer wall of the sealing member 300 abuts against the inner wall of the main housing 220. The outer wall of the sealing member 300 is extended with an abutting ring 340, and the abutting ring 340 axially abuts between the outer cylinder 112 and the main housing 220.

Specifically, the sealing member 300 includes a first sealing ring 310, a connecting ring 320, a second scaling ring 330, and an abutting ring 340. The first sealing ring 310 abuts between the outer wall of the connector 120 and the inner wall of the main housing 220. The second scaling ring 330 abuts between the inner wall of the connector 120 and the outer wall of the vent tube 210. The connecting ring 320 is connected between the first sealing ring 310 and the second sealing ring 330. The abutting ring 340 extends radially outward from the outer wall of the first sealing ring 310. In this embodiment, the seals between the main housing 220 and the connector 120, between the connector 120 and the vent tube 210, and between the outer cylinder 112 and the main housing 220 are respectively formed by using the first sealing ring 310, the second sealing ring 330, and the abutting ring 340, and the connection between the first sealing ring 310 and the second sealing ring 330 is formed by using the connecting ring 320, so that the first sealing ring 310, the second sealing ring 330, and the abutting ring 340 are formed as a whole, and the sealing member 300 can be integrally formed, which simplifies processing and assembly processes of the sealing member 300, omits positioning structures on the connector 120 and the vent tube 210 for positioning the sealing member 300, and simplifies structural designs of the connector 120 and the vent tube 210.

In an embodiment, referring to FIG. 4, one side of the sealing member 300 towards the connector 120 is formed with an accommodation groove 370. One end of the connector 120 away from the inner cylinder 111 is plugged into the accommodation groove 370, and the inner wall and the outer wall of the connector 120 respectively abut against the opposing inner walls of the accommodation groove 370. In this way, a bottom end of the connector 120 can be supported and limited by the sealing member 300, to ensure the mounting stability of the connector 120.

Specifically, the first sealing ring 310, the second sealing ring 330, and the connecting ring 320 are enclosed to form the accommodation groove 370. Two axial ends of the connector 120 respectively abut against the inner cylinder 111 and the connecting ring 320.

In an embodiment, referring to FIG. 4, the inner wall of the second sealing ring 330 is convexly provided with a first convex rib 350. The first convex rib 350 has an arc-shaped axial cross section and abuts against the outer wall of the vent tube 210.

The outer wall of the connecting ring 320 is convexly provided with a second convex rib 360. The second convex rib 360 has an arc-shaped axial cross section and abuts against the inner wall of the main housing 220.

During assembly of the aerosol generation device in the embodiments of this application, the mouthpiece body 110, the connector 120, and the sealing member 300 are first assembled as a whole and then mounted on the atomization structure 200. Specifically,
the connector 120 is first axially inserted into the inner cavity of the mouthpiece body 110 from the bottom end of the mouthpiece body 110 until the second clamping block 121 is snapped into the first clamping block 115, and the top end of the connector 120 axially abuts against the inner cylinder 111. Next, the sealing member 300 is sleeved on the connector 120 from the bottom end of the connector 120 until the connecting ring 320 abuts against the bottom end of the connector 120. Finally, the mouthpiece structure 100 is sleeved on the top end of the vent tube 210 as a whole, so that the elastic arm 124 is snapped with the convex ring 213 of the vent tube 210, and the abutting ring 340 abuts between the outer cylinder 112 and the main housing 220.

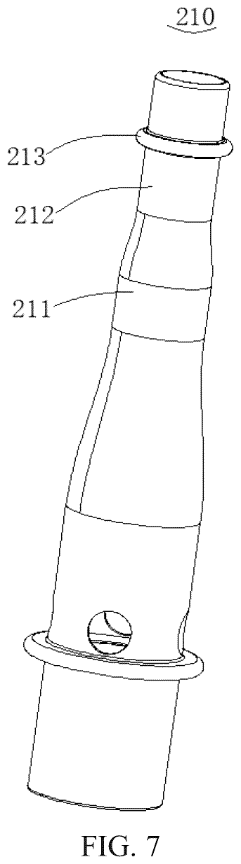

In an embodiment, referring to FIG. 7, the top end of the vent tube 210 includes a scaling section 211 and a snapping section 212. The sealing section 211 is used to hermetically abut against the sealing member 300. The snapping section 212 is convexly provided with a convex ring 213. The convex ring 213 is used to snap with the connector 120. The outer diameter of the scaling section 211 is greater than that of the snapping section 212. In this way, during assembly, when the snapping section 212 passes through the sealing member 300, the convex ring 213 does not scratch the sealing member 300.

In an embodiment, the convex ring 213 of the vent tube 210 is alternatively formed by stretching.

The foregoing descriptions are merely exemplary embodiments of this application, but are not intended to limit this application. Any modification, equivalent replacement, or improvement made without departing from the spirit and principle of this application shall fall within the protection scope of this application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A mouthpiece structure, comprising:
a mouthpiece body comprising an outer cylinder and an inner cylinder extending from a top end of the outer cylinder into an inner cavity of the outer cylinder; and
a connector arranged in the inner cavity of the outer cylinder, the connector and the inner cylinder being arranged in an axial direction of the outer cylinder, the connector being sleeved outside a vent tube,
wherein the inner cylinder comprises an air guide hole and a plug hole that are in communication with each other, the plug hole being plug-fitted with a top end of the vent tube,
wherein the air guide hole is configured to dock with a top end of the vent tube to guide an airflow out of the vent tube,
wherein the connector is configured to snap with the vent tube, and
wherein the connector is snapped with the outer cylinder.

2. The mouthpiece structure of claim 1, wherein an inner wall of the outer cylinder comprises a first clamping block,
wherein an outer wall of the connector comprises a second clamping block, and
wherein the first clamping block is, when driven by an external force, snappable into one side of the second clamping block away from the inner cylinder from one side of the second clamping block towards the inner cylinder, and locked.

3. The mouthpiece structure of claim 2, wherein the connector comprises an opening at a position corresponding to the second clamping block, the opening running axially through one end of the connector away from the inner cylinder, and the opening running radially through a side wall of the connector.

4. The mouthpiece structure of claim 1, wherein the connector comprises a window,
wherein an inner wall of the window is extended with an elastic arm, the elastic arm being configured to elastically abut against an outer wall of the vent tube, and
wherein the elastic arm is configured to elastically snap with a convex ring on an outer wall of the vent tube.

5. The mouthpiece structure of claim 1, wherein an inner diameter of the air guide hole gradually increases from the plug hole to a direction away from the plug hole,
wherein a minimum inner diameter of the air guide hole is less than an inner diameter of the plug hole, and
wherein the minimum inner diameter of the air guide hole is less than the inner diameter of the vent tube.

6. An aerosol generation device, comprising:
a vent tube;
a main housing; and
the mouthpiece structure of claim 1,
wherein the main housing is sleeved outside the vent tube,
wherein the mouthpiece structure is connected to a top end of the main housing, and
wherein the mouthpiece structure is sleeved on a top end of the vent tube.

7. The aerosol generation device of claim 6, further comprising:
a sealing member that abuts between an outer wall of the vent tube and an inner wall of the main housing, and
wherein the sealing member axially abuts between the outer cylinder and the main housing.

8. The aerosol generation device of claim 7, wherein the sealing member is sleeved between the vent tube and the main housing,
wherein an inner wall of the sealing member abuts against an outer wall of the vent tube,
wherein an outer wall of the sealing member abuts against the inner wall of the main housing,
wherein the outer wall of the sealing member is extended with an abutting ring, and
wherein the abutting ring axially abuts between the outer cylinder and the main housing.

9. The aerosol generation device of claim 8, wherein one side of the sealing member towards a connector comprises an accommodation groove,
wherein one end of the connector away from the inner cylinder is plugged into the accommodation groove, and
wherein an inner wall and an outer wall of the connector respectively abut against opposing inner walls of the accommodation groove.

10. The aerosol generation device of claim 7, wherein a top end of the vent tube comprises a sealing section and a snapping section,
wherein the sealing section hermetically abuts against the sealing member,
wherein the snapping section is convexly provided with a convex ring for snapping with the connector, and
wherein an outer diameter of the sealing section is greater than an outer diameter of the snapping section.
